(19) United States
(12) Patent Application Publication
(10) Pub. No.: US 2021/0065497 A1
(43) Pub. Date: Mar. 4, 2021

(54) METHOD AND APPARATUS FOR DISPENSING FUNDS IN A LOTTERY

(71) Applicant: Pollard Banknote Limited, Winnipeg (CA)

(72) Inventors: Nancy Bettcher, Winnipeg (CA); Michael John Brickwood, Winnipeg (CA); Richard Bennett John Roschuk, Dufresne (CA); Darren Martin Wareham, Winnipeg (CA); Andrew John Wojtowicz, Winnipeg (CA)

(21) Appl. No.: 16/551,160

(22) Filed: Aug. 26, 2019

(51) Int. Cl. G07F 17/32; G06K 19/06; G06K 7/14; G06Q 20/20; G07G 1/12

(52) U.S. Cl. CPC G07F 17/329; G06K 19/06037; G07G 1/12; G06Q 20/20; G06K 7/1417

(57) ABSTRACT

Apparatus for managing a lottery distribution includes a plurality of lottery cards carrying a unique machine-readable code readable by a Point of Sale (POS) system for purchase and activation of the lottery card by a customer. Each lottery card carries in customer readable format only part of the game data, which is covered by a scratch-off, necessary for a determination by the customer whether the lottery card is allocated to be either a winner of a predetermined prize or a non-winner of the lottery and the lottery control system is arranged to communicate to the POS system the remaining information for said determination to be printed on a POS receipt for the customer so that the customer can read the printed data on the receipt along side or through the card to determine whether the card is a winner.

This invention relates to a method and apparatus for operating a lottery or for dispensing funds in a lottery to customers of the lottery which can also be expressed as an apparatus for managing a lottery distribution.

### BACKGROUND OF THE INVENTION

Lottery tickets are well known and widely sold and typically comprised of a sheet material of paper or card stock on which is printed lottery information and various indicia for the playing of one or more games. Many such games are instant win type games where the customer can play the game or games by carrying out various functions, for example, opening pull tabs on a break-open ticket.

It is well known that the lottery tickets are managed by a control system typically managed by the ticket producer and the lottery to ensure that the tickets have allocated a predetermined outcome of winners, prizes and non-winners to dispense to the customers a predetermined proportion of the income obtained from the sale of the tickets.

### SUMMARY OF THE INVENTION

According to the invention there is provided an apparatus for managing a lottery distribution or for dispensing funds to customers in a lottery comprising:

a lottery control system comprising at least one programmed computer;

a plurality of lottery cards each comprising a substrate;

each lottery card being associated in the lottery control system by a unique code carried thereon;

the unique code containing no information which identifies to the customer whether the lottery card is either a winner of a predetermined prize or a non-winner of the lottery;

each of the lottery cards having printed thereon a Point of Sale (POS) code by which the lottery card is scanned through a POS system for purchase and activation of the lottery card by a customer;

the lottery control system containing data indicating a result of the lottery by which each lottery card is allocated to be a winner of a predetermined prize or a non-winner of the lottery;

wherein each lottery card carries in customer readable format only part of information necessary for a determination by the customer whether the lottery card is allocated to be either a winner of a predetermined prize or a non-winner of the lottery;

and wherein the lottery control system is arranged to communicate to the POS system remaining information for said determination to be printed on a POS receipt for the customer.

In case the customer loses access to the receipt, the lottery control system is arranged to provide said remaining information to the customer by an additional route, such as by text, web site or the like.

In some cases, the lottery control system is arranged to generate a predetermined result of the lottery by which each lottery card when printed is either a winner of a predetermined prize or a non-winner of the lottery, which predetermined result is associated with the code of the card. In this way the lottery results are predetermined in a conventional manner and the lottery control system contains a data base which associates the unique code of all of the lottery elements with the relevant result.

As an alternative, the lottery control system can be arranged to generate a pool of results of the lottery and to allocate a result from the pool to each card only when that card is activated. In this case the allocated result is associated in the lottery control system with the unique code of the card.

In some cases the lottery cards form a stand-alone lottery in which all of the prizes of the lottery are allocated to selected ones of the lottery cards. However in other cases there can be provided a plurality of lottery tickets each comprising a substrate, game symbols printed on the substrate and one or more removable coverings over the game symbols which are removable by the customer to reveal the symbols where some of the prizes are allocated to the lottery tickets and some to the lottery cards. That is in some cases the lottery tickets may be predetermined in conventional manner with the prizes associated with the lottery cards being assigned to a pool and then allocated when the cards are activated.

Thus in one embodiment, each lottery ticket and each lottery card are associated in the lottery control system with a predetermined result of the lottery by which the lottery ticket is either a winner of a predetermined prize or a non-winner of the lottery as identified to the customer by revealing the symbols, where the lottery cards each contain only part of information necessary to determine whether the card is associated with a prize in the lottery with remaining information for determination being printed on the separate substrate forming a receipt for the customer using information from the lottery control system after the card is scanned for purchase and activated.

In some options, the unique code of each lottery card is contained within the POS code but it may also be a separate code independent of the POS code.

In one embodiment, the game elements on the lottery card are covered by one or more removable coverings over the game symbols which are removable by the customer to reveal the symbols. However the remaining information printed on the receipt for the customer typically comprises simply a plurality of lottery symbols which are not covered by removable coverings since these can be readily printed by the POS receipt printer. That is preferably, the plurality of lottery symbols which are not covered by removable coverings are compared with the covered game elements on the lottery card when the covering is removed to determine whether the lottery card is either a winner of a predetermined prize or a non-winner of the lottery.

In one preferred arrangement, each lottery card has an opening therein with the remaining information printed on the receipt being arranged and dimensioned so as to be all visible simultaneously through the opening. This therefore in effect mimics the game data which is printed on the lottery ticket so that the card in conjunction with the receipt held by the customer at the opening provides an appearance similar to or equal to the lottery tickets themselves to be familiar in form to the customer.

In one embodiment the first part of the information comprises first game elements printed on the lottery card with the remaining information comprising further game elements.

Preferably the combination of the first information on the lottery card and the printed information contains full validation information that is only available after activation of the card.

Thus in general the lottery cards contain a unique identifying code used to identify each printed product where the code is used by the retail POS system to identify the product in inventory and trigger product-specific point-of-sale actions, where the retailer scans the code to sell and activate the lottery card and where the code contains the UPC information for the POS system to add the appropriate amount to the consumer's basket.

The arrangement herein provides in-lane versions of conventional scratch ticket containing only partial game elements which comprise a first game part containing first game elements with the remaining game elements printed on the POS system receipt after the ticket is scanned for purchase and activated.

This provides a significant security benefit with this invention that allows the sale of instant win scratch tickets at retail stores by only printing partial game data, hence eliminating any pre-screening attempts via mechanical intrusion methods such as micro-surgery and mechnical lifting.

Thus, for example, the lottery card can contain only partial game elements which comprise as the first game part “Your Numbers”, with the remaining game elements as a second part such as “Winning Numbers” printed on the POS system receipt after the card is scanned for purchase. The lottery card is then activated through a modified version of the same lottery control system as set out above.

The arrangement as disclosed herein contains full validation information that is only available after activation of the card.

For consumers that want to play the game, they combine the data on the card with the data printed on their receipt. For players that simply want to check the outcome without playing they can disregard the receipt and simply present their purchased, activated cards at any lottery validation terminal or ticket checker. A unique identifying activation code is used to identify each printed product. The code is used by the retail POS system to identify the product in inventory and trigger product-specific point-of-sale actions. The retailer scans the code to sell and activate the specific two-part ticket. The retailer verifies purchaser age. The code contains the UPC information for the POS system to add the appropriate amount to the consumer's basket

The code is printed on the back of the product and can be in the form of a long barcode (eg. Code 128-C), similar to that of a gift card. The digits in the code are also printed directly below the barcode in a human-readable format as numeric or alpha-numeric.

Part 1 of the game elements are printed under the scratch off area of the card. Part 1 game elements do not, in and of themselves, reveal the outcome that is whether the lottery card either a winner of a predetermined prize or a non-winner of the lottery.

Part 2 of the game elements are printed on the POS receipt along with the unique, identifying number with which it is associated. Part 2 game elements do not, in and of themselves, reveal the outcome.

The purchaser combines the Part 1 game elements with the Part 2 game elements to visually determine the outcome

A unique, predetermined validation barcode is printed on the lottery cards.

Once purchased and activated, the lottery cards serve as the bearer instrument. It alone can be used to validate and redeem any associated winnings, without the need for the POS system receipt.

The lottery cards do not require integration with a lottery's central gaming system. Central system integration is only required if in-lane validation and redemption is desired and offered by the retailer.

The lottery cards can have a predetermined winning or non-winning outcome assigned at the time of printing. In the event of loss/damage/theft of the lottery cards, the prize pool is diluted and potential winning/non-winning outcomes are lost or destroyed, potentially including the game's grand prize. For this reason, the prize structures of the lottery cards include many, lower-value top prizes that are widely distributed throughout the run. Over time, consumers and retailers discover the cards have no value until purchased/activated and shrinkage will decline. To address potential damage concerns, the formats of the lottery cards incorporate protective features such as a clear “pouch” covering laminated to the front of the card, or a card stock covering like PBL's proprietary Fusion products (Action Pack, Pop ‘n’ Play, etc.). Alternatively the prizes can be assigned dynamically when the cards are activated for example by selection from an assigned pool.

The innovations in this product are:

It is well known in the art that traditional instant win scratch off tickets contain all of the game data defining whether the ticket is a win or lose hidden under opaque scratch off. Lotteries are security sensitive to the possibility of pre-screening tickets, that is, separating winning tickets from non-winning tickets, prior to sale by the retailer, with little to no tamper evidence. Therefore, the opaque security coatings covering the game data must resist all known chemical, electrical and mechanical methods of intrusion.

This invention relies on the fact that the game data hidden under the opaque scratch off is incomplete and requires the lottery card to be purchased at POS and put in combination with the POS receipt in order to determine whether the card is a winning or losing card.

Therefore the lottery card itself possesses incomplete game data and would not be subject to the same methods of intrusion because there would be no motivation to pre-screen tickets. This would be a significant advantage for lotteries.

The game elements are split between the pre-printed, predetermined conventional ticket and the two-part ticket elements using the POS system receipt system, making it impossible to visually determine the outcome without both pieces.

The predetermined game outcome is only accessible to the player, retailer and/or self-service ticket checker once a purchase transaction is completed and the lottery cards are activated via the POS system.

Integration with the lottery's central gaming system is not required.

The arrangement disclosed herein where the second part of the game elements is provided on the POS sales receipt can be used by itself in combination with the conventional lottery tickets or can be used with a digital experience arrangement above. The following provides further detail of the features of the apparatus some of which can be used with the two-part system some with the digital experience system and some with both.

The activation code which is scanned for entry of data identifying the lottery card into the lottery control system may be a separate code independent of the POS code but also in some cases the activation code can instead be possibly contained within the POS Code and thus scanned simultaneously.

The assignment of the results from the pool can be done by random selection, but this could potentially change for each lottery. Some may not accept random selection, and may require sequential assignment, for example. Thus the mode of selection or assignment can be varied depending on the requirements of the lottery to whom the apparatus is supplied. In some cases, where the cards are printed and supplied as a “book” of the cards, the results may be assigned to a particular book of the cards and then selected at random for that book as the cards of the book are activated.

Alternatively, the same invention can be expressed as a method for dispensing funds to customers.

Thus the lottery control system is arranged to allocate to the lottery a plurality of predetermined options for results, some of which are provided on the lottery tickets as predetermined results printed on the tickets and some of which are provided to the pool for the digital presentation.

In the two-part system disclosed above, typically all of the tickets and cards have the prize associated therewith predetermined and held in the lottery control system for allocation to the ticket or card concerned. That is this information on the predetermined associated with the specific card under purchase is used to print the elements on the POS receipt which are used by the player/purchaser to determine the outcome.

Preferably the lottery cards are entered into inventory for payment by a retailer to the lottery only when the activation code is scanned.

The lottery control system can comprise a single networked computer, or a series of interconnected computers having access to the communications network via a gateway or other known networking system. The lottery control system can be a single system and in some cases includes a first lottery control component managed by the lottery and a second lottery control component managed by a supplier of the lottery tickets and the lottery cards in view of the different responsibilities involved in the management of the dispensing of the funds and the security, financial and licensing requirements involved.

The type of retail establishment may vary widely. For example, in certain embodiments, the retail establishments may be convenience stores, gas stations, pubs, and any other establishment that typically sells lottery tickets to the public. The present methodology and related system have particular usefulness for much larger retail establishments, such as multi-lane and “big-box” retail stores that are part of a national or other geographic chain, wherein the sale of lottery ticket sales has generally not been implemented due to the barrier of security and staffing requirements to manage and track activated and non-activated inventory of traditional instant lottery tickets.

A “lottery jurisdiction” is understood to be a geographic area, such as a state, territory, or the like, governed by a governmental authority. A typical example of a lottery jurisdiction is an individual state-sponsored lottery, such as the Georgia (USA) or Connecticut (USA) state lotteries. A lottery jurisdiction may also encompass multiple states or territories that participate in a national-scale lottery game, such as the PowerBall (Registered Trademark) and Mega Millions (Registered Trademark) games in the United States.

A “lottery authority” is understood to be the governmental body, agency, or other organization that governs play of lottery games in a particular jurisdiction. For example, the Connecticut Lottery Corporation is the lottery authority for play of lottery games in Connecticut. A lottery authority may also be an organization that governs play of multi-state games (games across multiple jurisdictions). An example of such an organization is MUSL (Multi-State Lottery Association) in the United States that administers the PowerBall (Registered Trademark) games for its member states.

A “host lottery system” is understood to be the system and associated entity that implements the logistical aspects of the lottery game for the lottery authority, such as printing and supplying tickets, providing server and computer services required to manage the various games, providing redemption services, and so forth. The host lottery system may be a system of the lottery authority, or may be implemented by a third party provider. An example of a host lottery system and associated entity is the system and services provided by Scientific Games International, Inc., of Alpharetta, Ga., USA.

In certain embodiments, the present method includes formatting the lottery cards for sale at the retail establishment with a purchase code and a separate data code. These codes may be in the format of a machine-readable bar code. The purchase code mimics a UPC (Universal Product Code) or other type of code format used by the retail establishment for purchase of non-lottery products, and conveys sufficient information for processing the sale of the lottery card via the retail establishment's POS (Point-of-Sale) system. Thus, for each sale of a lottery card at the retail establishment, the purchase code is input into the POS system of the retail establishment (e.g., by scanning the code) such that purchase of the lottery card mimics purchase of a non-lottery product in the POS system. In the POS system, the purchase code is linked to a database file wherein information necessary (e.g., price, discounts, etc.) for the purchase transaction is retrieved and processed. As with any product sold in the retail establishment, this database can be continuously updated with new lottery products, pricing, promotions, and the like.

The arrangement herein thus provides in one embodiment a dual-stream game where a subset of the game printed in the conventional scratch ticket process, with conventional, book-level activation and billing process, and another subset of the game used for a digital game experience or for the two part system, with different, single ticket-level activation and billing process. The tickets are subject to the conventional security systems well known and established for such tickets. The cards do not need the security systems because they have no value until activated so that the security aspects can be provided in the computer management system rather than at the physical ticket level.

The subset of plays related to the digital game experience are delivered as printed promotional pieces that are inert until activated. Then it becomes a digital play experience with a predetermined outcome that is assigned only at the time of activation.

The term “lottery card” is intended to refer to the component on which the first part of the game is provided or on which the codes are provided and is not intended to limit or imply a particular material from which the element is formed.

The following features are primarily related to the embodiment using the digital experience but some of them may be applicable to the two-part system disclosed herein.

### Customer Experience

A customer at for example a big-box retailer sees the product as a game card on a shelf near checkout or an aisle end cap, and makes an impulse purchase.

Using the store's existing POS system, the retail employee scans the product's retail code (UPC, EAN, Code-128, etc), is prompted to perform age verification, and optionally scan the activation barcode on the back of the game card if the retail code does not include the activation code. The retail staff member can then continue ringing through other products in the Consumer's cart

The activation or outcome assignment request is not sent until payment is confirmed.

The activation code and retailer data is contained in the activation or outcome assignment payload. The lottery control system, and typically that part managed by the supplier rather than the lottery, returns the assigned outcome from the pre-determined validation file.

The lottery control system, and typically that part managed by the Lottery retail system, is optionally sent a request to activate the assigned outcome from validation file as in the regular book or single-ticket activation process.

The customer visits lottery validation terminal/kiosk in a full-service lottery retailer, or a validation terminal in a big box store, if this exists, to collect minor prizes and presents digital barcode or printed validation barcode.

Major prizes require a visit to the Lottery head office, in a process similar to instant ticket processes today.

### Lottery Experience

The lottery cards can be designed to match/mimic the instant ticket counterpart using many of the same print options and innovations which are available. The lottery can order a desired amount of lottery cards on a first run of the game, and can re-order at any time. The lottery can disseminate the lottery cards to any retailer that has been set-up by the lottery control system.

### Retailer Experience

Tthe retailer works with the lottery control system to configure their Point-of-Sale (POS) system to facilitate activation when lottery card UPCs/EANs are scanned through a till. This business process is nearly identical to the existing gift card activation process which retail staff is already familiar with. The retailer is not required to manage inventory of the lottery cards, but should notify the Lottery when they require additional stock.

The lottery cards are essentially inert advertising pieces unless they have a pre-determined outcome assigned to them by the lottery control system via activation through a retail purchase.

The retailer is billed using the Lottery's defined and agreed billing process for lottery cards that are activated/sold through their POS system.

The lottery cards therefore contain the following information:

A code such as UPC/EAN/Code-128 product code used by the retail POS system to identify the product in inventory and trigger product-specific point-of-sale actions;

One point in this product when the prize is assigned on activation, is that the predetermined game outcome is only assigned to the card and available to the customer once a purchase has been made, not when the card is printed. The predetermined game outcome is assigned in the following way:

The Retail POS system transmits the “Activation” code and retailer data payload to the lottery control System;

The “activation” code is scrubbed through a number of security measures to ensure it is valid;

Predetermined outcome data (validation code and/or game/book/ticket number) from the reserved pool is assigned to the transmitted “activation” code;

The lottery control System returns the card's unique game-pack-ticket number o the Retail POS System; so it's clear that the game data is only applicable to that specific card;

Optionally, the Retail POS system transmits the predetermined outcome data to the Lottery Host component of the lottery control system to be made active for redemption;

Optionally, the Lottery Host component returns a response to the Retail POS System confirming successful activation of that predetermined outcome data.

### BRIEF DESCRIPTION OF THE DRAWINGS

One embodiment of the invention will now be described in conjunction with the accompanying drawings in which:

FIG. 1 is a schematic illustration of an apparatus according to the present invention for controlling the operation of a lottery and the dispensing of funds to customers of the lottery showing the embodiment in which the lottery cards are provided in a first part on the card and on a second part which is available to the player only when the lottery card is purchased.

FIG. 2 is a front elevational view of a combination of the lottery card and associated receipt according to the present invention.

### DETAILED DESCRIPTION

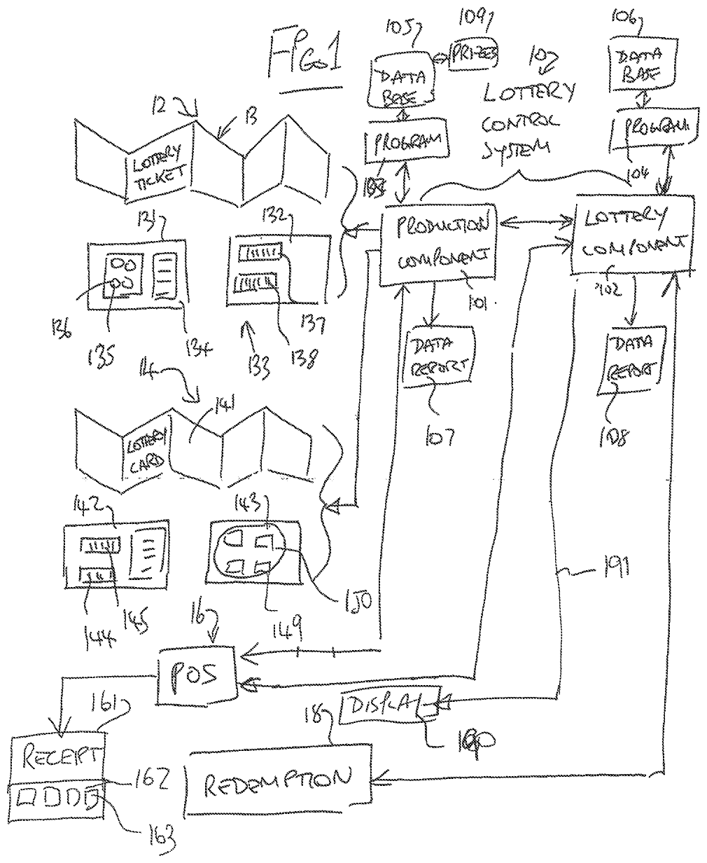

The apparatus for dispensing funds to customers in a lottery shown in FIG. 1 includes a lottery control system 10, a plurality of lottery tickets 12, a plurality of lottery cards 14, a POS terminal 16 and a lottery redemption terminal 18.

The lottery control system includes a production control component 101 and a lottery management control component 102. These operate together and share required information to carry out the functions defined herein. These use programing 103 and 104 and data bases or memories 105, 106. These can be operated to generate data reports 107 and 108 all as described herein.

The data base 105 of the production component is arranged to generate for a lottery a set of outcomes which winning prizes of different values and non-winners. These are provided in a prize set 109 to be used for the lottery tickets 12 and for the lottery cards 14.

The plurality of lottery tickets 12 includes a printed set of tickets 13 where each ticket 133 is printed on a substrate 134 and has a front surface 131 and a rear surface 132. On the front surface of the substrate is provided a conventional game ticket including game symbols 135 printed on the substrate and one or more removable coverings 136 over the game symbols which are removable by a customer to reveal the symbols. On the rear surface is provided a first code 137 for the POS terminal and a second code 138 for the activation system.

Each lottery ticket is printed by the production control component and is associated in the lottery control system with a predetermined result of the lottery by which the lottery ticket is either a winner of a predetermined prize or a non-winner of the lottery as identified to the customer by revealing the symbols.

The plurality of lottery cards 14 each comprise a substrate 141 with a front face 142 and a rear face 143. Each of the lottery cards has printed thereon a Point of Sale (POS) code 144 by which the lottery card is scanned through a POS system for purchase of the lottery card by a customer.

In this embodiment, each lottery ticket 12 and each lottery card 14 are associated in the lottery control system with a predetermined result of the lottery by which the lottery ticket is either a winner of a predetermined prize or a non-winner of the lottery as identified to the customer by revealing the symbols as set out in the set of prizes 109.

The lottery tickets are sold and managed in a conventional manner using the codes printed thereon including the POS code 137.

Also, each of the lottery cards has printed thereon the Point of Sale (POS) code 144 by which the lottery card is scanned through a POS system 16 for purchase of the lottery card by a customer. Yet further, each of the lottery cards having printed thereon a unique code 145 which is scanned for entry of data identifying the lottery card into the lottery control system 10. In this example the code 145 is part of the POS code 144 so as to be recognized by the POS terminal.

The codes 144 and 145 contain no information which identifies the lottery card as either a winner of a predetermined prize or a non-winner of the lottery.

In this embodiment, the lottery cards each contain first game elements 149 on either the front or rear surface which are typically covered by a scratch-off layer 150 to form a first part of information necessary to determine whether the card is associated with a prize in the lottery. That is the lottery card carries game information informing the player what is required to be a winner and only part of the game data necessary to determine whether the card is associated with a winning prize of not. From this game data therefore, the player cannot determine whether the card is a winner.

The remaining information for determination of the win/lose status is printed on a separate substrate 161 using information from the lottery control system 10 after the ticket is scanned for purchase and activated.

That is the lottery cards 14 contain a unique identifying code 144 used to identify each printed product, where the code is used by the retail POS system to identify the product in inventory and trigger product-specific point-of-sale actions.

The retailer scans the code to sell and activate the lottery card. This code 144 communicates with the POS system 16 and where the code contains the UPC information for the POS system to add the appropriate amount to the consumer's basket and to print the necessary POS receipt 161.

At the same time using the lottery control system 10, the remaining information for the determination of the prize status is also printed on the receipt 161 for the purchaser as indicated at 162 containing game elements 163.

Thus the first part of the information necessary to determine the status comprises first game elements 149 printed on the lottery card with the remaining information comprising further game elements 163 printed on the receipt 161.

The combination of the first information on the lottery card 14 and the printed information on receipt 161 contains full validation information that is only available after activation of the card.

The code 144 is printed on the front or rear of the lottery card 14 and can be in the form of a long barcode.

The purchaser combines the first game elements 149 with the further game elements 163 to visually determine the outcome if that is the wish of the purchaser. However the lottery card itself serves as the bearer instrument so that it alone can be used to validate and redeem any associated winnings, without the need for the POS system receipt and of course without the purchaser even checking the status themselves.

The game elements 149 on the lottery card are covered by one or more removable coverings 150, typically scratch-off, over the game symbols which are removable by the customer to reveal the symbols 149. The remaining information 162 printed on the receipt for the customer comprises a plurality of lottery symbols 163 which are not covered by removable coverings so that they can be readily printed by a POS terminal. The game to be played is typically one in which the plurality of lottery symbols 163 which are not covered by removable coverings are compared with the covered game elements on the lottery card when the covering is removed to determine whether the lottery card either a winner of a predetermined prize or a non-winner of the lottery.

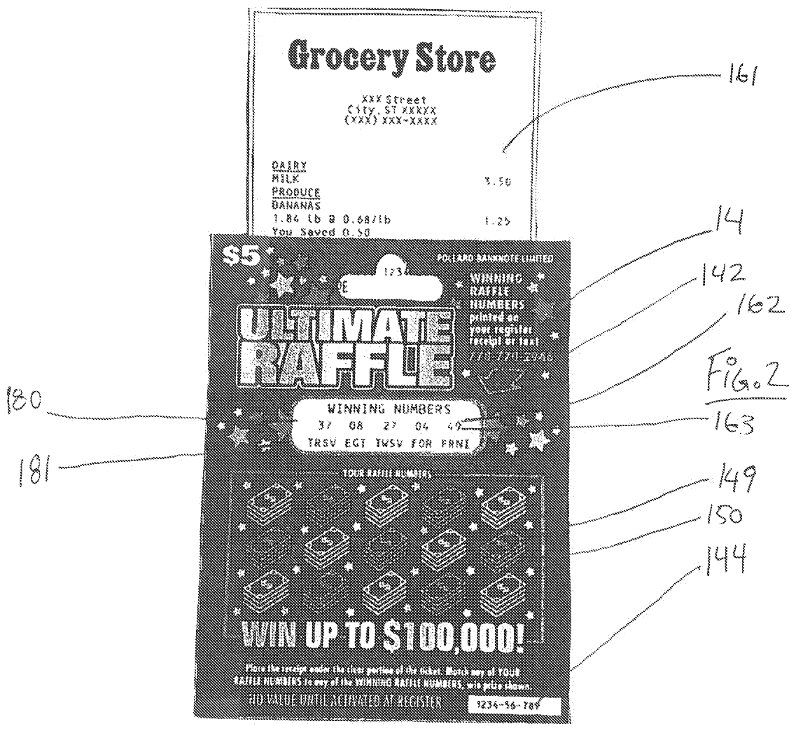

As shown at 180 in the card example shown in FIG. 2, each lottery card has an opening 181 or a translucent portion therein with the remaining information printed on the receipt 161 being arranged and dimensioned so as to be all visible simultaneously through the opening when the receipt is located behind the card as shown. That is the card contains an opening at a location similar to the location on the conventional lottery tickets where the customer would expect to find the game elements such as “winning numbers” so that those winning numbers are exposed through the opening mimicking the numbers on the conventional ticket. The customer then plays the combined elements forming the ticket in conventional manner and obtains the result. When the portion 180 is translucent it may form just a portion of the card or the whole card may be printed on translucent plastics material as disclosed in US Published application 2016/0339734 by the present applicant, the disclosure of which is incorporated herein by reference.

The system 10 may be a single networked computer, or a series of interconnected computers having access to the communications network via a gateway or other known networking system. Generally, the system 10 is configured to communicate with, manage, execute and control individual lottery terminal units 101, 102 within the lottery jurisdiction. The system 10 may include a memory 105, 106 for storing gaming procedures and routines, a microprocessor (MP) for executing the stored programs, a random-access memory (RAM) and an input/output (I/O) bus. These devices may be multiplexed together via a common bus, or may each be directly connected via dedicated communications lines, depending on the needs of the system 10.

As shown in FIG. 1 at 191, the lottery control system 102 is arranged to provide to the customer by an additional route such as on a display 190 when requested by the customer, for example if the data on the receipt 161 has gone astray. This can be by a smart phone connection using text or web pages. In one example, the lottery tickets 12 are omitted and the lottery is run wholly based on the cards 14 themselves so that the lottery cards 14 form a stand-alone lottery in which all of the prizes of the lottery are allocated to selected ones of the lottery cards.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An apparatus for managing a lottery distribution or for dispensing funds to customers in a lottery comprising:
a lottery control system comprising at least one programmed computer;
a plurality of lottery cards each comprising a substrate;
each lottery card being associated in the lottery control system by a unique code carried thereon;
the unique code containing no information which identifies to the customer whether the lottery card or lottery card is either a winner of a predetermined prize or a non-winner of the lottery;
each of the lottery cards having printed thereon a Point of Sale (POS) code by which the lottery card is scanned through a POS system for purchase and activation of the lottery card by a customer;
the lottery control system containing data indicating a result of the lottery by which each lottery card is allocated to be a winner of a predetermined prize or a non-winner of the lottery;
wherein each lottery card carries in customer readable format only part of information necessary for a determination by the customer whether the lottery card is allocated to be either a winner of a predetermined prize or a non-winner of the lottery;
and wherein the lottery control system is arranged to communicate to the POS system remaining information for said determination to be printed on a POS receipt for the customer.

2. The apparatus according to claim 1 wherein the lottery control system is arranged to provide said remaining information to the customer by an additional route.

3. The apparatus according to claim 1 wherein the lottery control system is arranged to generate a predetermined result of the lottery by which each lottery card when printed is either a winner of a predetermined prize or a non-winner of the lottery, which predetermined result is associated with the code of the card.

4. The apparatus according to claim 1 wherein the lottery control system is arranged to generate a pool of results of the lottery and to allocated to each card only when activated a result from the pool, which allocated result is associated in the lottery control system with the unique code of the card.

5. The apparatus according to claim 1 wherein the lottery cards form a stand-alone lottery in which all of the prizes of the lottery are allocated to selected ones of the lottery cards.

6. The apparatus according to claim 1 wherein there is provided a plurality of lottery tickets each comprising a substrate, game symbols printed on the substrate and one or more removable coverings over the game symbols which are removable by the customer to reveal the symbols where some of the prizes are allocated to the lottery tickets and some to the lottery cards.

7. The apparatus according to claim 1 wherein the unique code of each lottery card is contained within the POS code.

8. The apparatus according to claim 1 wherein the first part of the information comprises first game elements printed on the lottery card with the remaining information comprising further game elements.

9. The apparatus according to claim 1 wherein the game elements on the lottery card are covered by one or more removable coverings over the game symbols which are removable by the customer to reveal the symbols.

10. The apparatus according to claim 1 wherein the remaining information printed on the receipt for the customer comprises a plurality of lottery symbols which are not covered by removable coverings.

11. The apparatus according to claim 10 wherein the plurality of lottery symbols which are not covered by removable coverings are combined with the covered game elements on the lottery card when the covering is removed to determine whether the lottery card either a winner of a predetermined prize or a non-winner of the lottery.

12. The apparatus according to claim 1 wherein each lottery card has an opening therein with the remaining information printed on the POS receipt being arranged and dimensioned so as to be all visible simultaneously through the opening.

13. The apparatus according to claim 1 wherein each lottery card has at least one translucent portion thereof with the remaining information printed on the POS receipt being visible through said at least one translucent portion.

14. The apparatus according to claim 1 wherein each lottery cards carries a validation code so that it can by itself be used to validate and redeem any associated winnings, without the need for the receipt.

15. The apparatus according to claim 1 wherein said lottery control system comprises a single networked computer.

16. The apparatus according to claim 1 wherein said lottery control system comprises a series of interconnected computers.

17. The apparatus according to claim 1 wherein said lottery control system comprises a first lottery control component managed by the lottery and a second lottery control component managed by a supplier of the lottery tickets and the lottery cards.

18. The apparatus according to claim 1 wherein the lottery control system is connected to a communications network including said POS system.

19. The apparatus according to claim 1 wherein said remaining information contains game elements which do not, in and of themselves, reveal whether the lottery card either a winner of a predetermined prize or a non-winner of the lottery.
